(19) United States
(12) Patent Application Publication
(10) Pub. No.: US 2010/0275738 A1
(43) Pub. Date: Nov. 4, 2010

(54) Socket Insert Adapter

(76) Inventor: James W. Taylor, JR., Medford, OR (US)

Correspondence Address: JERRY HAYNES LAW, 2 N OAKDALE AVENUE, MEDFORD, OR, 97501, US

(21) Appl. No.: 12/434,609

(22) Filed: May 1, 2009

(51) Int. Cl. B25B 13/06

(52) U.S. Cl. 81/121.1

(57) ABSTRACT

A hollow shaped socket insert adapter rotatively driven by a single socket driver for tightening, loosing, and removing various sizes of nuts/bolts.

### FIELD OF THE INVENTION

The present invention in general relates to a socket insert. More particularly, it relates to a hollow shape socket insert adapter used in conjunction with a socket driver for tightening, loosening, removing various sizes of nuts and bolts.

### BACKGROUND OF THE INVENTION

Sockets are one of the most commonly used mechanical tools for driving nuts and bolts. Most of the earlier standard socket drivers were designed with specific metric or SAE size for fastening nuts/bolts thus each time a different socket driver was required for driving nuts/bolts of various dimensions and shapes. Some adjustable socket drivers having a movable jaw and a fixed jaw are available in the prior art to engage nuts/bolts of various dimensions and shapes but such socket drivers are not efficient to prevent rotation of nuts/bolts and do not offer grip to operate on different shapes and sizes of fasteners.

One of the common problem with inserts used in socket drivers of the prior art is the sharp corners which cause the spinning and slippage while providing torque to the inserts because of the improper locking between the insert and socket driver. The major drawback with existing split side, gap wall, and similar inserts available in the prior art is that they fail to provide the durability, strength, and efficiency for driving large diameter of nuts/bolts.

Thus, there is a longstanding need to design insert adapters which can be driven by a single socket driver efficiently to operate on a large range of nuts and bolts of different sizes and shapes.

### SUMMARY OF THE INVENTION

Accordingly, it is a prime objective of the present invention to overcome the above mentioned disadvantages of the prior art by providing a hollow shaped socket insert adapter for tightening, loosening, and removing various sizes of nuts/bolts.

Another object of the present invention is to provide a plurality of hollow shaped socket insert adapters rotatively driven by a single socket driver for tightening, loosing, removing the various sizes of nuts/bolts.

Another objective of the present invention is to provide unique design inserts with rounded outside corners and rounded inside corners to maximize the torque on the flat wall of the insert.

Another objective of the present invention is to provide a relatively inexpensive hollow shaped socket insert adapter for tightening, loosing, removing the various sizes of nuts/bolts.

Another objective of the present invention is to provide a plurality of hollow shaped socket insert adapters of different sizes and different shapes with variable inner diameter specific to the size of the nuts/bolts to be driven.

The present invention has a further objective to hold the hollow shaped socket insert adapter securely inside the socket driver using a spring ball detent.

A further objective of the present invention is to provide an efficient, light weight, compact adjustable socket insert for socket drivers.

Yet another objective of the present invention is to provide a socket insert which can operate on interchangeable metric or SAE sizes using the same socket driver.

A further objective of the present invention is to provide a hollow shape socket insert adapter permitting the use of a wrench to drive a wrench socket.

Embodiments of the present invention provide a hollow shaped socket insert adapter rotatively driven by a single socket driver for tightening, loosing, removing the various sizes of nuts/bolts. A plurality of hollow shaped socket insert adapters with variable inner diameter has been provided to operate on smaller dimensions of nuts/bolts. The nuts/bolts have dimensions smaller with reference to the size of the socket driver cavity. Hollow shaped socket insert adapters of a single shape are capable of driving nuts/bolts of different sizes and shapes. Each of the hollow shaped socket insert adapters is provided with rounded outside corners and rounded inside corners to maximize the torque on the flat wall of the insert adapter when rotatively driven by a socket driver. The hollow shaped socket insert adapter specific to the size of the subject nut/bolt to be driven is chosen and placed inside the socket driver cavity. Force is applied to the socket driver body enabling the hollow shape socket insert adapter to tighten, loosen, and remove the subject nut/bolt.

### BRIEF DESCRIPTION OF THE DRAWINGS

The disclosure will now be made, by way of example, with reference to the accompanying drawings, in which:

FIG. 1 is a perspective view of the hollow shaped socket insert adapter for use in conjunction with the socket driver, in accordance with an embodiment of the present invention.

FIG. 2 is a top view of the hollow shaped socket insert adapter of FIG. 1 for use in conjunction with the socket driver, in accordance with an embodiment of the present invention.

FIG. 3 is a magnified view of the corner of the hollow shaped socket insert adapter of FIG. 1 for use in conjunction with the socket driver, in accordance with an embodiment of the present invention.

FIG. 4A is a cross sectional view of the hollow shaped socket insert adapter of FIG. 1 taken along the wall, for use in conjunction with the socket driver, in accordance with an embodiment of the present invention.

FIG. 4B is a cross sectional view of the hollow shaped socket insert adapter of FIG. 1 taken along the corners, for use in conjunction with the socket driver, in accordance with an embodiment of the present invention.

FIG. 5A is a top view of the hollow shaped socket insert adapter of FIG. 1, for use in conjunction with the socket driver, in accordance with an embodiment of the present invention.

FIG. 5B is a top view of the hollow shaped socket insert adapter of FIG. 1, for use in conjunction with the socket driver, in accordance with another embodiment of the present invention.

FIG. 6 is a perspective view of the socket driver with the hollow shaped socket insert adapter of FIG. 1 conformed to the cavity of the socket driver, in accordance with an embodiment of the present invention.

FIG. 7 is an illustrative view of the plurality of the hollow shaped socket insert adapters of FIG. 1 with variable inner diameter to use in conjunction with single socket driver, in accordance with an embodiment of the present invention.

FIG. 8 is an exemplary view of a plurality of the hollow shaped socket insert adapters of different shapes and different sizes for use in conjunction with the socket diver, in accordance with an embodiment of the present invention.

FIG. 9 is a perspective view of the hollow shaped socket insert adapter and socket driver with provision for spring ball detent, for use in conjunction with the socket driver, in accordance with another embodiment of the present invention.

FIG. 10 is a perspective view of an additional embodiment of the invention showing the arrangement wherein the hollow shaped socket insert adapter is adapted to be employed along with the socket wrench to operate on nuts/bolts, in accordance with another embodiment of the present invention.

FIG. 11 is a block diagram depicting the practice and use of the hollow shaped socket insert adapter, in accordance with an embodiment of the present invention.

### DETAILED DESCRIPTION OF THE INVENTION

Embodiments of the present invention provide a socket insert for tightening, loosening, and removing various nuts/bolts of smaller dimensions used in conjunction with a single socket driver. The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to practice the disclosure and are not intended to limit the scope of the claims. Furthermore, there is no intention to be bound by any expressed or implied theory presented in the preceding technical field, background, brief summary or the following detailed description.

Embodiments of the present invention provide a hollow shaped socket insert adapter rotatively driven by a single socket driver for tightening, loosing, and removing the various sizes of nuts/bolts. A plurality of hollow shaped socket insert adapters with variable inner diameter has been provided to operate on smaller dimensions of nuts/bolts. Hollow shaped socket insert adapters of different shapes to rotatively drive nuts/bolts of different shapes have also been provided. Each of the hollow shaped socket insert adapters is provided with rounded outside corners and rounded inside corners to maximize the torque on the flat wall of the insert adapter when rotatively driven by a socket driver. The hollow shaped socket insert adapter specific to the size of the subject nut/bolt to be driven is chosen and placed inside the socket driver cavity. Force is applied to the socket driver body enabling the hollow shaped socket insert adapter to tighten, loosen, and remove the subject nut/bolt.

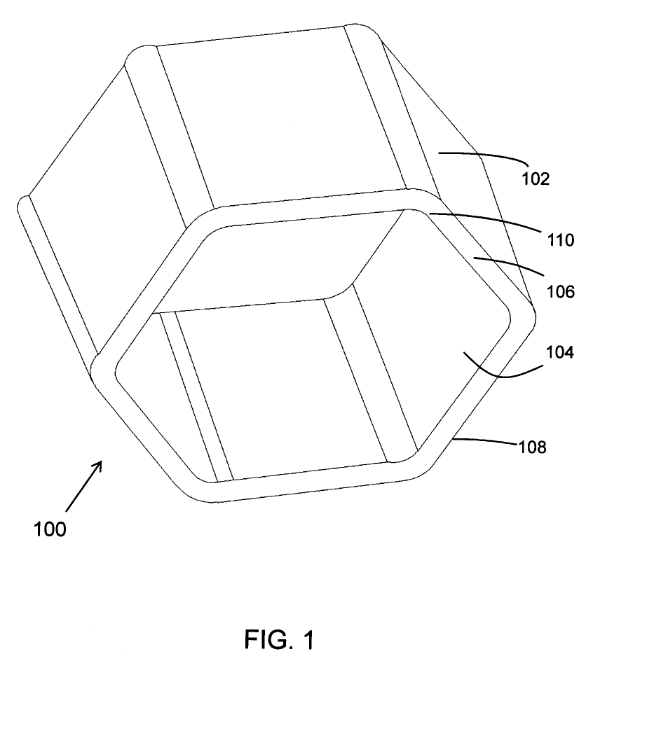

Referring now to FIG. 1, I present a perspective view of the hollow shaped socket insert adapter 100 for use in conjunction with the socket driver, in accordance with an embodiment of the present invention.

Hollow shaped socket insert adapter 100 is a hollow insert that fits into the cavity of a socket driver. In an embodiment of the present invention, socket insert adapter 100 is composed of any metal to absorb heavy impact while being rotatively driven by a socket driver. Examples of metal include, but are not limited to steel, brass, iron, titanium, and copper. The hollow shaped socket insert adapter may be of any shape formed of edges. Examples of shapes include a square, hexagonal, octagonal, decagonal, and dodecagonal, any polygonal or any special shape.

The socket insert adapter 100 is of varied sizes to accommodate the nuts/bolts of smaller dimensions with reference to the size of the socket driver. In an embodiment of the present invention, the sizes of the hollow shaped socket insert adapters are designed with different sizes, the sizes varying with a difference of at-least 1/16 inches (or about 1 mm). Most effective dimensions for the hollow shaped socket insert adapters vary from one inch (or 25 mm) to 10 inch (or 255 mm). In an embodiment of the present invention, the socket insert adapter 100 has SAE (Society of Automotive Engineers) sizes. In another embodiment of the present invention, metric sizes corresponding to the SAE sizes are available. Further, hollow shaped socket insert adapters have interchangeable SAE to metric sizes or vice versa.

In an embodiment of the present invention, socket insert adapter 100 has an outer wall 102 and an inner wall 104 indicating that socket insert adapter 100 has a thickness 106. The thickness of the hollow shaped socket insert adapter is governed by the size of nuts/bolts to be driven. The outer wall of socket insert adapter 100 is structured to mechanically co-operate with the socket driver enabling it to conform to the cavity of the socket driver allowing it to tighten, loosen, and remove various smaller dimensions of nuts/bolts. The inner wall is configured to engage nuts/bolts of smaller dimensions and fits on the head portion of nuts/bolts.

In an embodiment of the present invention, socket insert adapter 100 has an outer configuration 108 and an inner configuration 110. The outer configuration is designed to conform to the cavity of a socket driver. The inner configuration interacts with the head portion of nuts/bolts to be driven. The construction of the outer configuration may or may not be similar to the construction of the inner configuration. For example, the outer configuration of the hollow shaped socket insert adapter may be selected from, but not limited to, a circle, square, pentagonal, hexagonal, decagonal, dodecagonal, and any polygonal and the inner configuration of the hollow shape socket insert adapter may be selected from, but not limited to, a circle, square, pentagonal, hexagonal, decagonal, dodecagonal, and any polygonal, indicating that the hollow shape socket insert adapter that are 6 pt. (hexagonal) on the outside can be 4 pt, 5 pt, 6 pt, 8 pt., 12 pt., SAE or metric dimension on the “inside” of the hollow shaped socket insert adapter. This enables the single socket driver to operate on nuts/bolts of different shapes and smaller dimensions effectively. In an embodiment of the present invention, various SAE to SAE; SAE to metric; metric to metric; metric to SAE; 6 pt. to 6 pt.; 6 pt. to 8 pt.; 6 pt. to 12 pt.; 12 pt. to 12 pt.; 12 pt. to 8 pt.; 12 pt. to 6 pt. combinations are possible. The exercise of different hollow shaped socket insert adapters enables a great variety of socket driver dimensions and configurations. For example: if one has a 3″ SAE hexagonal (6 pt.) socket driver, this socket driver can now become a platform for tightening, loosening, and removing nuts/bolts of different configurations having dimensions smaller than 3″. The combination of outer configurations 108 and inner configurations 110 vary in great variety.

In an embodiment of the present invention, the outer configuration 108 of the hollow shaped socket insert adapter is similar to the cavity of socket driver to fit well to the cavity of the socket driver. In another embodiment of the present invention, outer configuration 108 of the hollow shaped socket insert adapter is not similar to the cavity of socket driver.

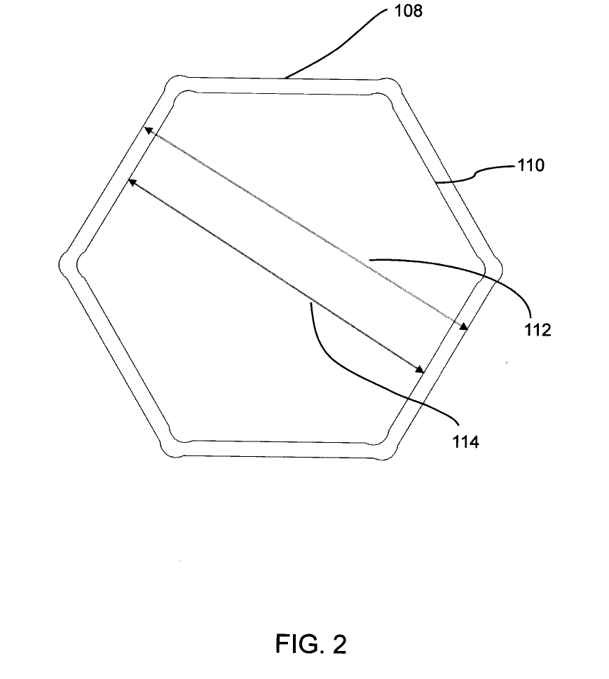

FIG. 2 is a top view of hollow shaped socket insert adapter 100 of FIG. 1 for use in conjunction with the socket driver, in accordance with an embodiment of the present invention.

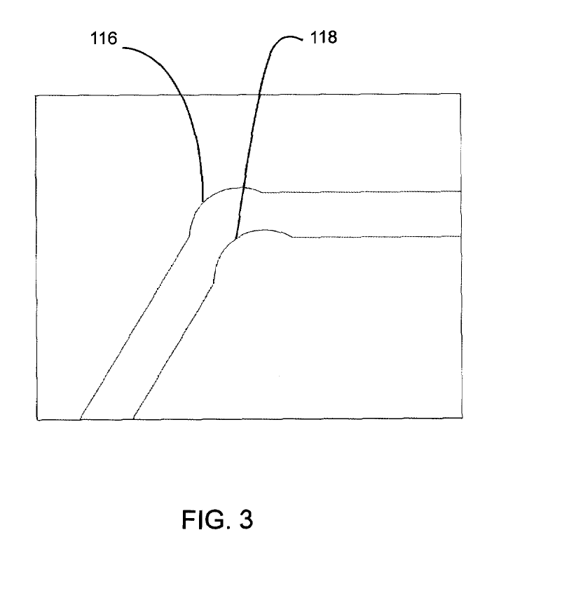

In an embodiment of the present invention, socket insert adapter 100 has an outer diameter 112 to fit inside the socket driver cavity and a variable inner diameter 114 to operate on large range of smaller sizes of nuts/bolts. The variable inner diameter 114 of the hollow shaped socket insert adapter conforms to the head portion of nuts/bolts of different sizes. The hollow shaped socket insert adapter has rounded corners. Details corresponding to the rounded corners have been provided in conjunction with FIG. 3.

FIG. 3 is a magnified view of the corner of hollow shaped socket insert adapter 100 of FIG. 1 for use in conjunction with the socket driver, in accordance with an embodiment of the present invention.

The socket insert adapter 100 is designed to have rounded “outside” corners 116 and rounded “inside” corners 118 which enables concentrating more torque upon the flat walls of the hollow shape insert rather than at corners. This helps to reduce the possibility of “rounded” corners upon the nut or bolt head portion being tightened or loosen. The rounded “outside” corners 116 and rounded “inside” corners 118 of the hollow shape socket insert adapter securely holds socket insert adapter 100 inside the socket driver cavity and prevents it from spinning and slippage.

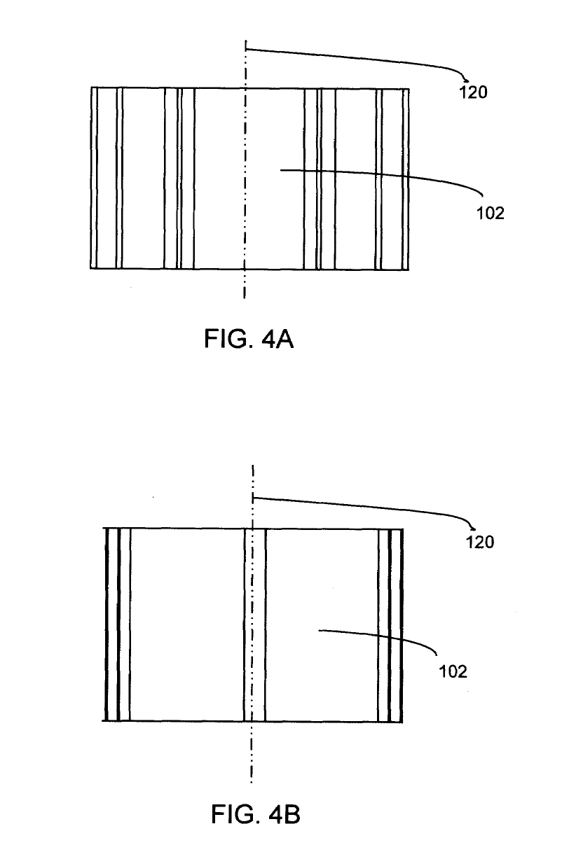

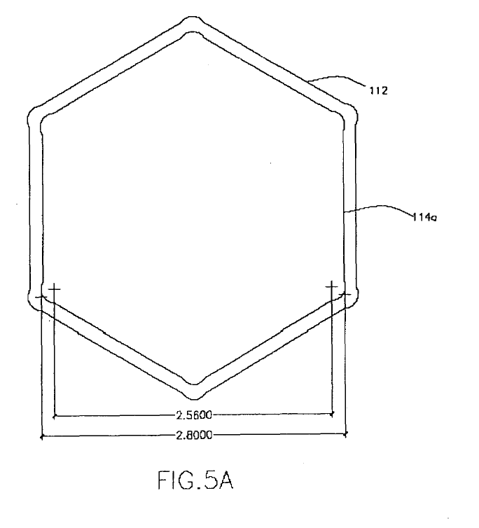

Referring now to FIG. 4A and FIG. 4B, I present a cross sectional view of the hollow shape socket insert adapter 100 of FIG. 1 taken along the wall and along the corners respectively, for use in conjunction with the socket driver, in accordance with an embodiment of the present invention.

The hollow shaped socket insert adapter has outer wall 102 concentric about longitudinal axis 120 configured to conform to the cavity of the socket driver. Socket insert adapter 100 is configured to slidably and non-rotatably engage a nut/bolt to be driven.

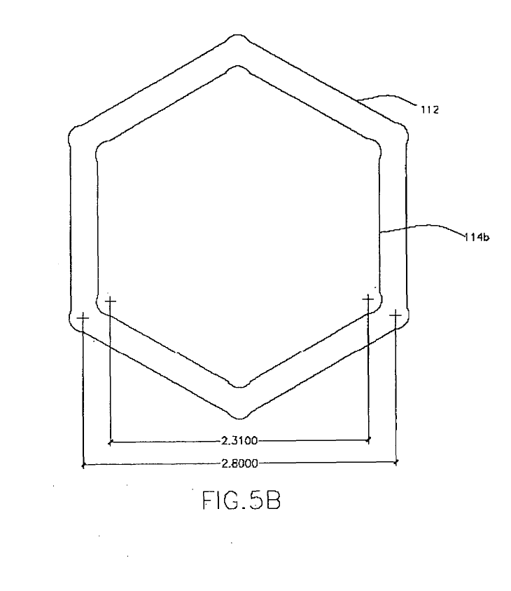

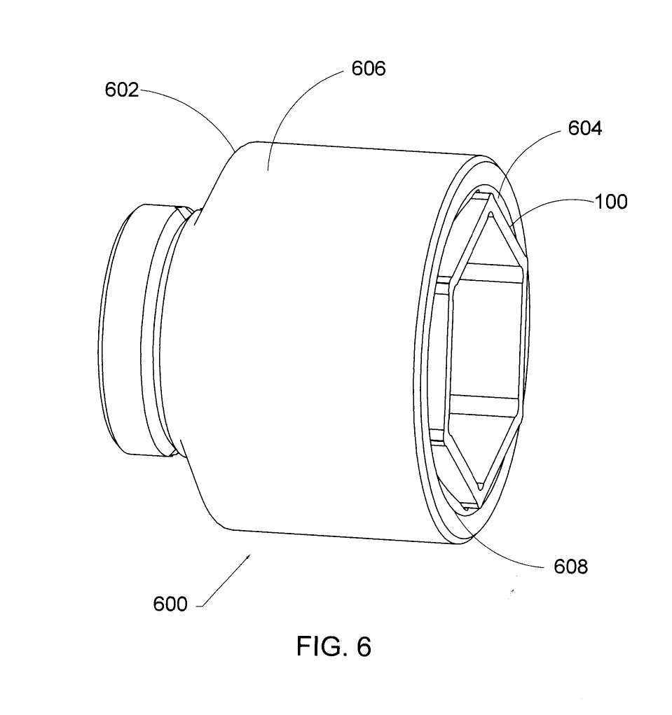

FIG. 5A and FIG. B are top views of a hollow shaped socket insert adapter 100 of FIG. 1, for use in conjunction with the socket driver, in accordance with an embodiment of the present invention.

Both, FIG. 5A and FIG. 5B present socket insert adapter 100 showing an outer diameter 112 to fit inside the socket driver cavity and a inner diameter 114a and 114b which is different for each case. The variable inner diameter is achieved by varying (increasing or decreasing) thickness 106 of the hollow shaped socket insert adapters. In an embodiment of the present invention, increasing the thickness of the hollow shaped socket insert adapter decreases the inner diameter of the hollow shape socket insert adapter. The varying inner diameter enables the hollow shaped socket insert adapter to tighten, remove, and loosen various nuts/bolts of smaller dimensions.

FIG. 6 is a perspective view of socket driver 600 with hollow shaped socket insert adapter 100 of FIG. 1 conformed to the cavity 604 of the socket driver, in accordance with an embodiment of the present invention.

Socket driver 600 has a socket driver body 602 enclosing a socket driver cavity 604. Outer wall 606 of socket driver and inner wall 608 of socket driver define the structure of the socket driver. Socket driver cavity 604 accommodates the hollow shaped socket insert adapter. Outer wall 102 of socket insert adapter 100 interacts with inner wall 608 of socket driver for rotatively driving nuts/bolts of smaller dimensions. Inner wall 104 of socket insert adapter 100 is configured to engage nuts/bolts of smaller dimensions and fits on the head portion of nuts/bolts. Preferably, adapter 100 extends slightly beyond the rim of inner wall 608, most preferably about 1/16″. This slight extension provides ensures that the inner wall rim will not interfere with the application of maximum torque for tightening and loosening actions.

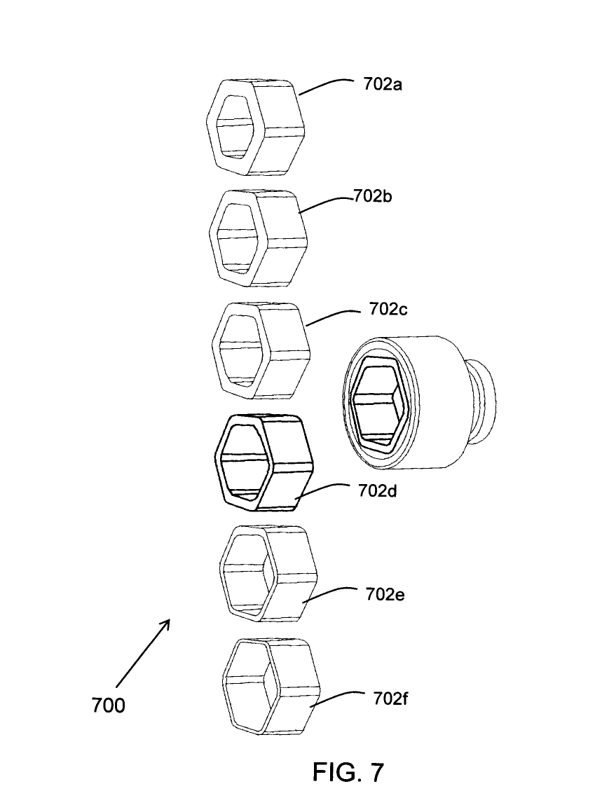

FIG. 7 is an illustrative view of the plurality of hollow shaped socket insert adapters 700 of FIG. 1 with variable inner diameter to use in conjunction with single socket driver, in accordance with an embodiment of the present invention.

The hollow shaped socket insert adapters 702a, 702b, 702c, 702d, 702e, 702f have a fixed outer diameter 112 and a different inner diameter 114. The sizes of the hollow shape socket insert adapters vary with a difference of at-least 1/16 inches (or about 1 mm). The varying inner diameter 114 enables the hollow shape socket insert adapters to fit on different smaller dimensions of nuts/bolts. Thus, one socket driver is enabled to be used to tighten, loosen, and remove nuts/bolts of different sizes and shapes.

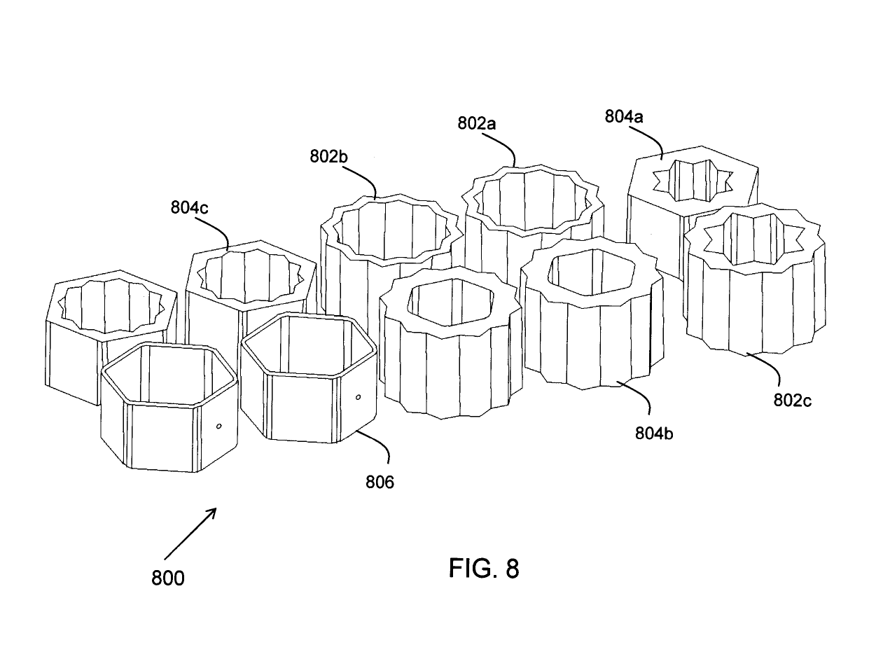

FIG. 8 is an exemplary view of a plurality of hollow shaped socket insert adapters 800 of different shapes and different sizes for use in conjunction with the socket driver, in accordance with an embodiment of the present invention.

In an embodiment of the present invention, the hollow shaped socket insert adapter has a fixed outer diameter 112 and a variable inner diameter 114. The variable inner diameter 114 of the hollow shape socket insert adapter conforms to the head portion of nuts/bolts of different sizes. Inserts 802a, 802b, 802c are examples of inserts having a fixed outer diameter and a variable inner diameter.

In another embodiment of the present invention, the hollow shaped socket insert adapter has an outer configuration 108 and an inner configuration 110. The construction of the outer configuration may or may not be similar to the construction of the inner configuration. For example: the outer configuration of the hollow shaped socket insert adapter may be selected from, but not limited to, a circle, square, pentagonal, hexagonal, decagonal, dodecagonal, and any polygonal and the inner configuration of the hollow shape socket insert adapter may be selected from, but not limited to, a circle, square, pentagonal, hexagonal, decagonal, dodecagonal, and any polygonal. The combination of outer configurations 108 and inner configurations 110 vary in great variety. Thus, by means of a series of hollow shaped socket insert adapters, single socket driver is employed to operate upon a large number of nuts/bolts of different size and shapes. Inserts 804a, 804b, 804c are examples of inserts with different inner and outer configuration.

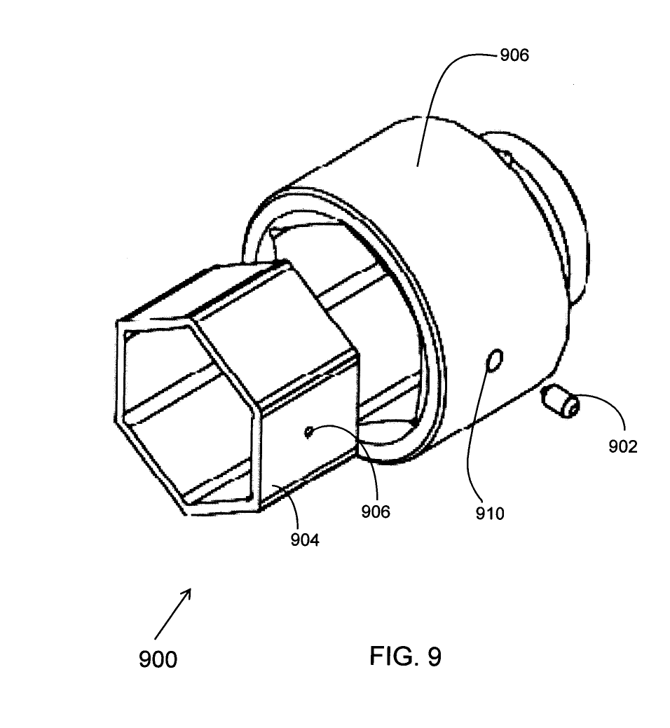

In another embodiment of the present invention, the hollow shaped socket insert adapters are adapted to be used with spring ball detent. Details corresponding to inserts for spring ball detent have been provided in conjunction with FIG. 9. Insert 806 is adapted to be used with spring ball detent.

FIG. 9 is a perspective view of the hollow shaped socket insert adapter with provision for spring ball detent 902, for use in conjunction with the socket diver, in accordance with another embodiment of the present invention. Preferably, spring ball detent 902 can be added to socket driver 910 in manufacture, or afterwards as a modification.

Spring ball detent 902 is a simple mechanical arrangement used to hold hollow shape socket insert 904 securely within socket driver 910 while operating upon nuts/bolts. The spring ball is a single, usually metal sphere, sliding within a bored cylinder, against the pressure of a spring, which pushes the ball against the hollow shaped socket insert adapter, which carries hole 906. Spring ball detent 902 passes through hole 910 (in the socket driver body) and hole 906 (in the hollow socket insert) to hold the hollow socket insert in place while rotatively driving the nuts/bolts of different shapes and sizes. Preferably, spring ball detent 902 is affixed permanently to the socket driver cavity wall.

In another embodiment of the present invention, the hollow socket insert is held securely in place using a magnetic metal for production of hollow socket insert. In another embodiment of the present invention, the hollow socket insert is held in place using pins.

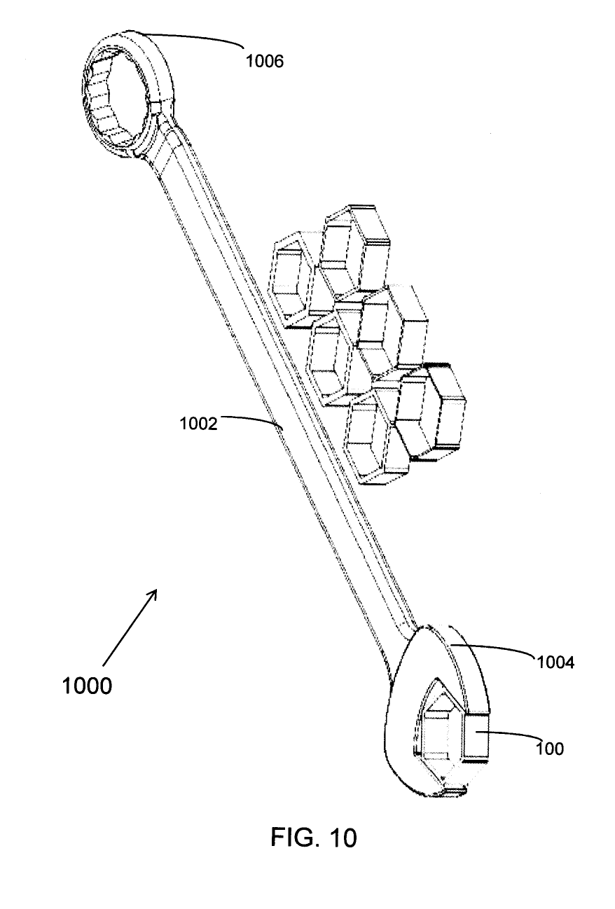

FIG. 10 is a perspective view of an additional embodiment of the invention 1000 showing the arrangement wherein the hollow shape socket insert adapter is adapted to be employed along with the socket wrench to operate on nuts/bolts, in accordance with another embodiment of the present invention.

Socket wrench 1002 is a type of tightening tool used to tighten, loosen, and remove nuts/bolts. In an embodiment of the present invention, socket wrench is an open end socket wrench 1004. In another embodiment of the present invention, socket wrench is a closed box end wrench 1006. The socket wrench is enabled to use socket insert adapter 100 for tightening, loosening, and removing nuts/bolts of different dimensions by receiving socket insert adapter 100 in the cavity at its end.

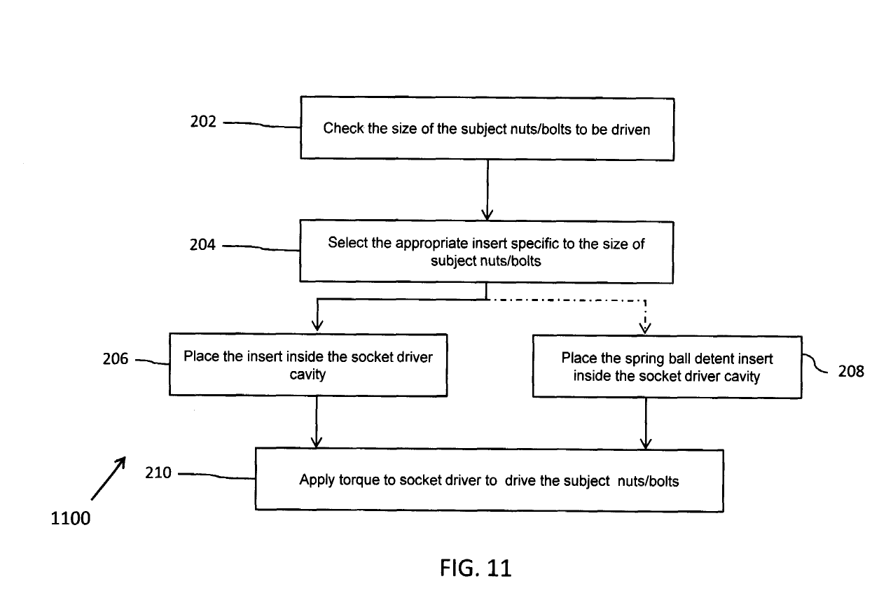

Referring now to FIG. 11, I present a block diagram 1100 depicting the practice and use of the hollow shaped socket insert adapter, in accordance with an embodiment of the present invention.

At step 202, the dimension and shape of the nut/bolt to be driven, is checked. At step 204 an appropriate hollow shaped socket insert adapter specific to the size of subject nut or bolt head dimension is selected. At step 206, the hollow shaped socket insert adapter is placed inside the socket driver cavity. In another embodiment of the present invention, hollow socket insert having a spring ball detent is placed within the socket driver/socket wrench cavity at step 208. Socket driver/socket wrench with hollow shaped socket insert adapter is now ready for application of torque to tighten, loosen, or remove the subject nut or bolt. At step 210, torque force is applied on the socket driver/socket wrench. The torque force may be applied by manual, electric, hydraulic, or pneumatic means.

The hollow shaped socket insert adapters described in the invention fulfill the objects set forth at the beginning of the description and provide means whereby a single socket driver/socket wrench may be employed to operate on a large range of nuts/bolts of different size and shapes at a substantial saving in weight, space, and cost.

While the illustrative embodiments of the disclosure have been described above, it will be recognized and understood that various modifications can be made in the disclosure and the appended claims are intended to cover all such modifications which may fall within the spirit and scope of the disclosure.

I claim:

1. A hollow shaped socket insert adapter rotatively driven by the socket driver for tightening, loosening, removing nuts/bolts of various sizes comprising:
a. a socket driver body with one side open cavity to place a socket insert adaptor inside the cavity and other side closed for providing torque to the hollow socket insert adaptor placed inside the cavity;
b. a plurality of socket insert adapters wherein each of the plurality of socket insert adapters conforms to the cavity of the socket driver body;
c. a plurality of socket insert adapters provided with an outer diameter to fit inside the socket driver cavity and variable inner diameter specific to the size of the nuts or bolts to be driven; and
d. a plurality of socket insert adapters each of which is provided with rounded corners to maximize torque on a flat wall of the insert adapter.

2. A socket insert adapter of claim 1, wherein the socket insert adapter is employed to rotate nuts/bolts of sizes smaller than the sizes of the socket driver cavity.

3. A socket insert adapter of claim 1, wherein the socket insert adapter is enabled to accommodate the nuts/bolts of interchangeable SAE to metric dimensions.

4. A socket insert adapter of claim 1, wherein the rounded corners of the socket insert adapter hold the hollow shaped socket insert adapter securely inside the socket driver.

5. A socket insert adapter of claim 1 wherein the shape of socket insert adapter is similar to nut/bolt structure and the shape of nut/bolt can be chosen among 4 pt, 6 pt, 8 pt or 12 pt.

6. A socket insert adapter of claim 1, wherein the rounded “outside and inside” corners of hollow shape socket insert adapter prevent the socket insert adapter from spinning and slippage.

7. A socket insert adapter of claim 1, wherein the size of socket insert adapter varies from about 1 inch to about 10 inches.

8. A socket insert adapter of claim 1, wherein the size of socket insert adapter varies from about 25 mm to about 255 mm.

9. A socket insert adapter of claim 1, wherein the socket insert adapter can further use the spring ball detent for securely holding the insert inside the socket driver cavity.

10. A hollow shaped socket insert adapter rotatively driven by a socket wrench for tightening, loosening, and removing nuts/bolts of various sizes comprising:
a. a wrench end body to receive the socket insert adapter inside the body;
b. a plurality of socket insert adapters wherein each of the plurality of socket insert adapters conforms to the cavity of the wrench end body to rotate nuts/bolts of smaller sizes;
c. a plurality of socket insert adapters provided with an outer diameter to fit inside the wrench end body cavity and variable inner diameter specific to the size of the nuts or bolts to be driven; and
d. a plurality of socket insert adapters each of which is provided with rounded “outside and inside” corners to maximize the torque on the flat wall of the insert adapter.

11. A socket insert adapter of claim 10, wherein the wrench end body can be chosen among the box end wrench, open end wrench, socket wrench or any combination thereof.

12. A socket insert adapter of claim 10, wherein the socket insert adapter is employed to rotate nuts/bolts of sizes smaller than the sizes of the wrench end body cavity.

13. A socket insert adapter of claim 10, wherein the socket insert adapter is enabled to accommodate the nuts/bolts of interchangeable SAE to metric dimensions.

14. A socket insert adapter of claim 10, wherein the rounded “outside and inside” corners of the socket insert adapter hold the hollow shape socket insert adapter securely inside the wrench end body.

15. A socket insert adapter of claim 10, wherein the shape of socket insert adapter is similar to nut/bolt structure and the shape of nut/bolt is selected from sizes 4 pt, 6 pt, 8 pt, and 12 pt.

16. A socket insert adapter of claim 10, wherein rounded “outside and inside” corners of the socket insert adapter prevent the socket insert adapter from spinning and slippage.

17. A socket insert adapter of claim 11, wherein the size of socket insert adapter ranges from about 1.0 inch to about 10 inches.

18. A socket insert adapter of claim 11, wherein the size of socket insert adapter ranges from about 25 mm to about 255 mm.
